(19) United States
(12) Patent Application Publication
(10) Pub. No.: US 2010/0205136 A1
(43) Pub. Date: Aug. 12, 2010

(54) System and Method for Modeling and Predicting Security Threats

(75) Inventor: Thomas G. Glass, III, San Antonio, TX (US)

Correspondence Address: CHOWDHURY & GEORGAKIS, P.C, P.O. Box 17299, Sugar Land, TX, 77496, US

(73) Assignee: Southwest Research Institute, San Antonio, TX (US)

(21) Appl. No.: 12/367,975

(22) Filed: Feb. 9, 2009

(51) Int. Cl. G06N 5/02; G06F 17/00

(52) U.S. Cl. 706/50

(57) ABSTRACT

A computer-implemented system and method of organizing, storing, and analyzing intelligence data. The intelligence data is structured as “SDO” (standardized data object) data, each SDO containing data representing source intelligence or target intelligence or both. The system receives threat definitions from the user, and processes the SDOs and threat definitions to determine if there are location/time coherencies that indicate a security threat. A “threat map” displays one or more SDOs in that location, each SDO having a geographical radius and a time bar.

### TECHNICAL FIELD OF THE INVENTION

This invention relates to security intelligence analysis, and more particularly to a computer-implemented system for acquiring and structuring threat-related data, defining threat criteria, and determining and displaying predictive indicators of potentially vulnerable locations, assets or events.

### BACKGROUND OF THE INVENTION

The field of geopolitical “intelligence” analysis involves the collection, evaluation and dissemination of vital political, economic, and scientific information for the purpose of providing and maintaining security. The role of intelligence in government, business settings and law enforcement is essential today. A professional intelligence analyst needs computer skills, analytic skills, a general grasp of current events, and a desire to research.

A growing technology is the use of computer systems to model and analyze intelligence data. With the help of such systems, analysts work all over the world for organizations and agencies in areas of government (homeland security, drug enforcement, etc.), private business and state and local law enforcement.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates an intelligence analysis system in accordance with the invention.

FIG. 2 illustrates the data acquisition process of the system of FIG. 1 in further detail.

FIGS. 3 and 4 illustrate examples of the results of analysis performed by the system, displayed as graphical output.

FIG. 5 illustrates a “virtual time machine”, resulting from the static analysis process of the system.

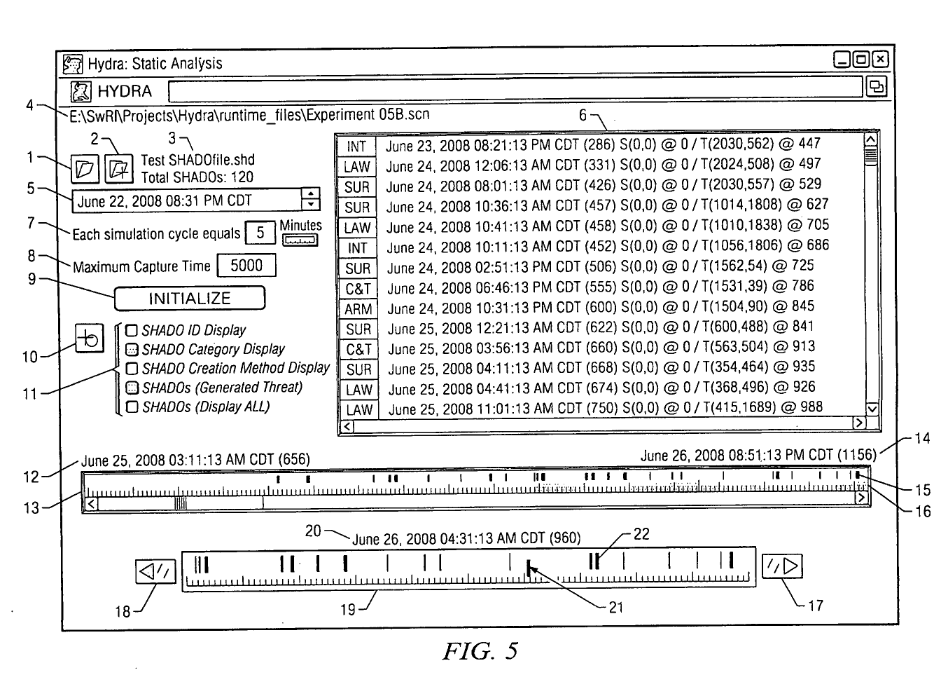

### DETAILED DESCRIPTION OF THE INVENTION

The invention described herein falls into the general field of security intelligence analysis. One aspect of the invention is a computer-implemented system for capturing disparate intelligence data, receiving threat criteria definitions, and determining and displaying predictive indicators of potentially vulnerable locations, assets or events.

The system implements a data fusion methodology for detecting security threats against a variety of static and dynamic targets. “Data fusion” is generally defined as the use of techniques that combine data from multiple sources to achieve inferences that are more efficient and more accurate than if they were achieved by means of a single data source.

The approach described herein involves converting intelligence data into a standardized form, referred to herein as “standardized data objects” or “SDOs”. These SDOs are combined with operational data such as high value targets, dynamic events, and transportation of hazardous materials. Operational data may be categorized as static (e.g., fixed site locations) or dynamic (e.g., materials being transported by a vehicle).

Using analyst-provided threat definitions, the data fusion process correlates potential threat information (in the form of SDOs) with known or projected operational data (in the form of threat definitions) using semantics, logical relationships, location, and time. A strength of system 100 is its ability to discern threats embedded in large amounts of diverse, multi-source, multi-format data.

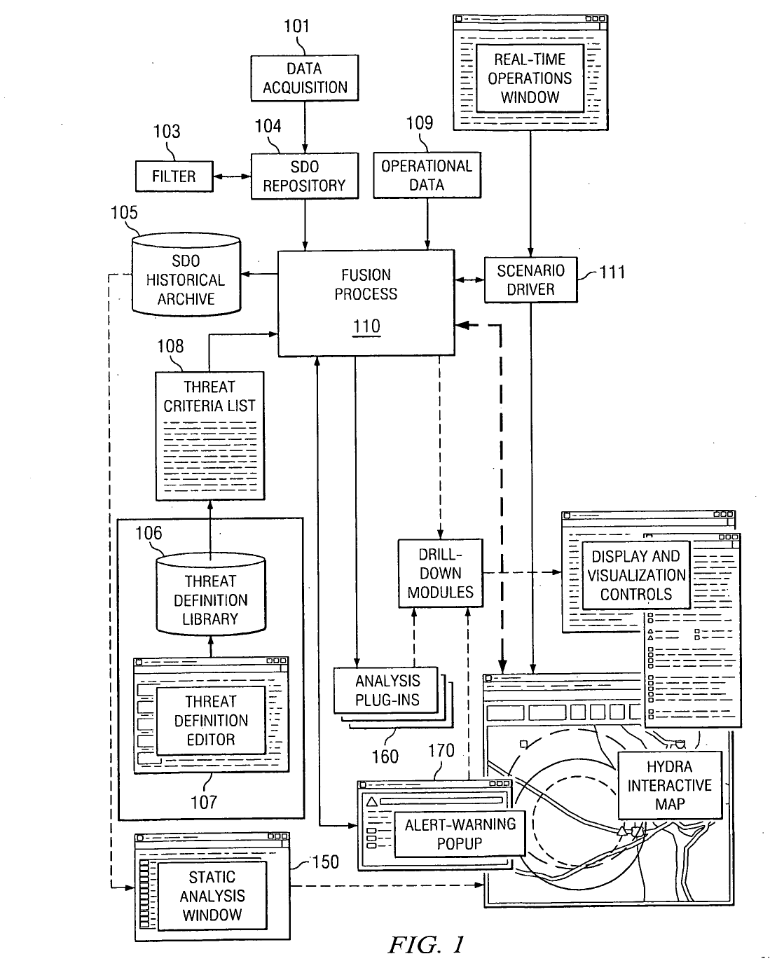

FIG. 1 illustrates a processing system 100 in accordance with the invention. System 100 has at least nine basic processing features:

(1) Periodic and intelligent acquisition of data from multiple data sources

(2) Standardization and data characterization

(3) Use of third-party plug-ins for items (1) and (2)

(4) Data reduction and intelligent filtering based on semantics, time, and location

(5) Analyst-developed threat definitions and threat libraries

(6) Data fusion using five analytical techniques and application of one or more threat definitions to identify threats

(7) Drill-down access to various levels of data processed in the stream facilitated by the use of the standardized objects built in (2)

(8) Static analysis based on stored standardized data for non-real-time analysis using a “virtual time machine”

(9) Use of third party plug-ins for additional, post-standardization analysis

The sections below describe each of these features.

Data Acquisition

System 100 provides for an open data acquisition process 101, which accepts data from diverse data sources. Third-party plug-ins may be used to perform data extraction, query, interpretation, and standardization operations.

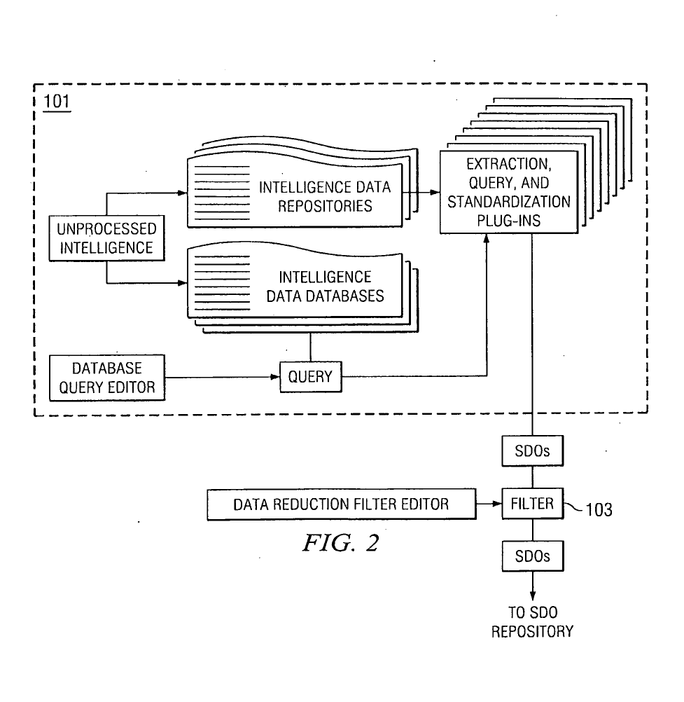

FIG. 2 illustrates data acquisition process in further detail, as well as the resulting SDOs. Five data acquisition categories are defined, based on the type, interpretation requirements, and organization of intelligence data at the source.

Intelligent Data Extraction

This type of data acquisition determines how to extract intelligence from an unorganized data source before interpreting and standardizing the extracted data into an SDO. This type of extraction is the most sophisticated and is applied to the least pre-processed data.

Raw Crawler Data Extraction

This category assumes a higher level of data organization at the source. The process is analogous to web crawlers and agent-based modules and gathers intelligence for processing into SDOs.

Interpretive Raw Document Data Extraction

For this category of data acquisition, data has already been organized into a document (albeit in a wide variety of formats) known to contain intelligence data. However, the extracted data still require interpretation before standardization into an SDO.

Noninterpretive Raw Document Data Extraction

This category differs from the previous one in that the extracted data require minimal interpretation to produce an SDO.

Metaprocessed Document Data Extraction

This category applies to data that has been metaprocessed and that can be extracted, standardized, and placed directly into the SDO repository with a minimum of additional processing.

In addition to the data extraction methods described above, a database query mechanism may be used to acquire data from source databases. This mechanism uses query specifications from the analyst.

Regardless of the source and method of acquisition, the data collected by system 100 is referred to herein as “intelligence data”.

Standardization and Data Characterization

An SDO (standardized data object) represents a single, discrete piece of acquired intelligence, based on intelligence data. Each SDO has one of three possible configurations: intelligence source information, intelligence target information, or a combination of the two.

Intelligence source information is intelligence data about events that have already occurred, such as the capture of a weapons cache. These events may or may not be associated with locations and times.

Intelligence target information is information derived from semantic data in the intelligence pointing to a future time and/or location [e.g., a meeting takes place (source) where a future attack is discussed for a time and location in the current active map area (target)].

An SDO may lack source or target information, but not both. An SDO may contain both source and target information, if the source data is relevant to the current map context. If available, a corroboration level as well as a reliability factor for both source and target data is embedded as part of the SDO during creation.

During threat analysis processing, as described below, a threat definition determines what geographical areas are to be considered. SBO with times and locations outside an area being processed are not considered during processing for that area.

Acquisition/Standardization Plug-Ins

To facilitate extensibility and flexibility, system 100 has a plug-in architecture. This type of architecture allows third-party suppliers to expand capabilities by writing modules that perform tasks within the framework of system 100. Intelligence-specific data acquisition and standardization plug-ins perform the data extraction and query processes based on security levels, repository and database requirements, document types, and interpretation levels of raw intelligence.

Data Reduction and Intelligent Filtering

As is also illustrated in FIG. 2, a filtering process 103 allows an analyst to further reduce the post-standardized data set to manageable proportions. Because filtering is performed on the SDOs, a single filtering format and processing step is built into the system's architecture. Filtering can be applied to all SDOs, whether created from extracted data or built directly from database query plug-in operations. Once filtered, SDOs are stored in the SDO repository 104 for internal analysis, real-time processing, and threat detection. SDOs may also be archived in a historical database 105.

Specifications for filter process 103 can be loose or tight, and can be saved into filter specification files. During setup for a real-time session, saved filters can be assigned to one or more repositories. These will be operative during runtime only for the assigned repository-filter combinations. Acquisition filter criteria can be composed of time ranges, location ranges, semantic specifications, corroboration level, reliability, and security access levels. A typical filter might be used to only allow highly corroborated data to pass through to the real-time analysis, thus minimizing clutter associated with the vast amount of available information.

Threat Criteria and Threat Libraries

A feature of system 100 is its ability to discern threats embedded in a large quantity of incoming data characterized by semantics, location, and time.

Threat definition library 106 stores any number of analyst-defined threat definitions. Each threat definition is based on one of the five data fusion techniques described below. Different versions of the same methodology may appear in the library 106 to cover more cases or to make the processing require fewer resources in a given time period.

In addition to the time and location aspects of data fusion, threat definitions allow the user to define semantic requirements relevant to the analysis. Evaluation criteria using categories, subcategories, subtext information, and keywords can be defined to support the semantic interpretation aspect of the threat detection process and to provide flexibility in levels of evaluation detail and specificity. As threat library 106 evolves, it becomes more refined and more sophisticated in the detection of subtle variations and combinations of SDOs in all three areas.

A threat definition tool 107 allows the analyst to develop one or more threat definitions for a real-time analysis session or for standard threat monitoring. Each methodology has its own specific set of control parameters, and the analyst can specify all details using the tool. A viewer 108 for examining and cross-referencing all items in a threat library is also provided. Threat definitions from multiple files can be merged with others to form a large, comprehensive threat detection library 106.

Data Fusion Process

Data fusion process 110 applies user-defined “threat definitions” to SDOs and operational data to determine threats. More specifically, data fusion process 110 detects threats by examining the cohesion (in time and space) of multiple SDOs with static and dynamic operational data in various combinations.

The results of data fusion process 110 are graphically displayed as “threat maps”. A scenario driver 111 stores maps and operates in conjunction with fusion process to provide threat map scenarios associated with assets and events. The scenarios are based on the operational data from database 109, and may be real or simulated. As stated above, operational data may be static or dynamic, but in general, pertains to a place, thing or event that could be the target of a threat.

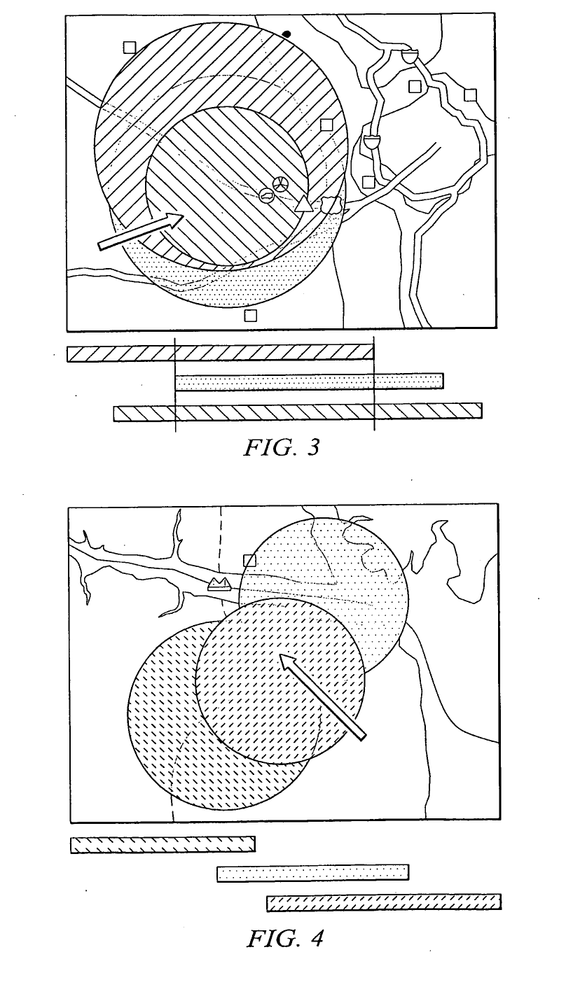

FIGS. 3 and 4 each illustrate an example of a threat map, each of which graphically illustrate SDOs and cohesion among SDOs. Because locations and times may be ill-defined in the raw intelligence data, a “radius of interest” is developed from the data along with a “relevance” life-span defined for the item. Together with semantic categorization and refinement, an SDO characterizes intelligence data in time and space. Semantic coherency and cohesion in time and space among two or more SDOs may indicate a potential threat.

In both FIGS. 3 and 4, location cohesion is displayed as intersecting SDO radii on a map. Time cohesion is displayed as overlapping SDO bars. Each SDO has an associated color, used for both its geographical radius and time bar.

The user-defined threat definition determines which data fusion technique will be applied by process 110. Three types of threat detection data fusion combinations are implemented and are available to the analyst (the user of system 100) in five categories.

1. Data fusion is represented at it simplest level when examining SDOs for common location and time. This process identifies SDOs with enough cohesion to represent a possible threat. For example, FIG. 3 shows three highly cohesive SDOs in both time and space. FIG. 4 shows three minimally cohesive SDOs in space with no cohesion in time (the three bars do not overlap).

2. Data fusion can evaluate SDOs in combination with static operational data (e.g., purchase of a large amount of explosive chemicals within close proximity of a populated area, bridge, tunnel, or nuclear facility) or with dynamic operational data (e.g. suspicious activity near a planned event such as a concert or convention). This technique requires data fusion in either the space domain or the time domain but not both.

3. The most complex conceptual data fusion technique involves evaluation of SDOs in combination with both static and dynamic operational data. This includes consideration of the time domain as well as location. As an example, intelligence points to several suspicious activities involving “watch-list” individuals with explosive munitions (SDO data) associated with a railway bridge (static data) on a scheduled hazardous waste shipment route (projected transport vehicle location, i.e. dynamic data).

The following paragraphs briefly outline five threat detection processes of data fusion process 110.

Generic Scanning

This process examines map locations in an orderly, user-specified manner. Each point in a generic scan is evaluated with respect to overlapping SDOs and semantic specifications in the threat definition. Generic scanning threat definitions can use varying offsets and scan rates to allow multiple scans to run quasi-concurrently and cover large areas in detail without taxing system resources. Generic scans can cover large areas for screening purposes and do not take into account potential targets, populated areas, events, or other map features.

High-Value Target Evaluation

High-value targets are defined as part of the static operational data that is known to system 100 at all times. Examples of these targets are airports, nuclear fuel cycle facilities, and refineries. Because their locations are known, examination of overlapping SDOs at these locations is more specific and efficient than with the generic scan method.

Population Area Scans

This process is similar to the generic scan except that scanning is confined to defined population areas. Population areas are also part of the static operational data. In these cases, scanning can be performed with a much finer scan rate. It is also more efficient because large unpopulated areas of the countryside are not evaluated as in the generic scan.

Dynamic Events

All of the previous scans include the time domain only as it relates to the life span of each SDO, because x-y points on the map, high-value targets, and population areas are all fixed locations over time. Dynamic events such as conventions, concerts, and sporting events have a location and a (transient) life span on the map at their given location. The data fusion and evaluation process of system 100 takes these factors into account and evaluates each dynamic event at the location and time along with any associated SDOs. A “Look Ahead” feature evaluates where SDOs and dynamic events will coincide at a future time.

Dynamic Transports

These elements represent movement of hazardous material from one map location to another along routes specified in the static operational data. They include ground, rail, waterway, and air transportation routes. When hazardous materials are transferred from one mode to another, the cargo is especially vulnerable. Evaluation of transports differs from other evaluation methods because the location of the target changes over time. The process can evaluate the projected path of transports along with SDO locations, cargo, hazard type, and proximity to other elements (e.g., high-value targets, population areas, and dynamic events). This methodology represents the most complex data fusion technique offered by the system.

As an example, FIG. 3 illustrates a threat detected in connection with nuclear material transport.

Drill-Down

Referring again to FIG. 1, a number of drill down modules provide windows and displays that allow a user to access data at different levels of detail. The unique nature of the SDO and its associated source data make drill-down operations especially efficient and useful.

For example, from an alert pop-up window 170 (appearing when a threat is detected), the analyst may drill-down directly to detailed information about a selected SDO. Each SDO panel, in turn, provides a small drill-down component that can be used to access deeper information about the raw intelligence used to build that particular SDO.

Static Analysis and the Virtual Time Machine

System 100 may operate in “real-time” meaning that threat data is processed as it arrives. Alternatively, SDOs generated during real-time analysis can be stored at any time in historical database 105. This database 105 can be used to examine and analyze SDO dynamics in a non-real-time environment. A Static Analysis process 150 provides access to the SDOs stored in the historical database. One or more sets of SDOs can be loaded and viewed in the same way they were during an original real-time analysis session. Some drill-down capabilities are available as well.

Using a “Virtual Time Machine”, the analyst can also control the time domain during static analysis. This means that the time can be incremented or skewed forward and backward in time in order to examine SDO relationships and cohesions. Static analysis of SDOs uses the same map as for all other map operations.

FIG. 4 illustrates the Virtual Time Machine.

1—Loads a set of SDOs from a historical database (replaces all static data currently in memory)

2—Loads a set of SDOs and merge with those currently loaded

3—Displays latest loaded file and current number of loaded SDOs

4—Displays the currently loaded scenario file (if any); required for static analysis

5—Set the “time zero” date and time

6—List of currently loaded SDOs (entries show category icon and abbreviated data)

7—Features for setting the time granularity (as in real-time operations)

8—Maximum capture time extent

9—Initialize the static analysis (required before using virtual time machine)

10—Used to select one or more SDOs for display of detailed information

11—Display controls for examining SDO details directly on the map display

12—Time for the low end of the movable window

13—Scrollable panel window for selecting the time window for detailed static analysis

14—Time for high end of the movable window

15—Category color indicators for capture time of all SDOs

16—Movable window that selects time range for the detailed static analysis panel

17—Steps forward one cycle in the detailed static analysis panel

18—Steps backward one cycle in the detailed static analysis panel

19—Detailed static analysis panel for controlling the static analysis

20—Current time as selected using the blue time indicator handle

21—Draggable time indicator arrow for static analysis

22—Category color indicators for capture time of all SDOs

Analysis Plug-ins

Third-party developers can extend the analytical, post-standardization capabilities of the system by creating and integrating additional features through analysis plug-ins 160. These plug-ins follow specific protocol requirements to process SDOs in the environment of system 100. These plug-ins can provide functions such as SDO manipulation, statistical processing, post-event analysis, weather modeling, dispersion modeling, damage assessment, cost-benefit analysis, resource management, charts and graphs, and others.

What is claimed is:

1. A computer-implemented method of organizing, storing, and analyzing intelligence data, comprising:
generating a number of SDOs (standardized data object) based on the intelligence data, each SDO containing data representing source intelligence or target intelligence or both;
storing operational data representing targets;
storing a number of data fusion processes, each data fusion process representing one of the following threats:
the existence of SDOs at any location within a specified region at during the same time;
the existence of SDOs at a specified target location;
the existence of SDOs in a specified population area;
the existence of SDOs during a specified event;
the existence of SDOs during a specified transport activity;
processing the SDOs, the operational data, and at least one data fusion process to determine if any SDOs indicate a threat;
displaying a threat map, which displays one or more SDOs in that location, each SDO having a geographical radius and a time bar.

2. The method of claim 1, wherein each SDO contains data representing a corroboration level.

3. The method of claim 1, wherein each SDO contains data representing a reliability factor.

4. The method of claim 1, further comprising the step of generating alert data if one or more SDOs are coherent in time and location.

5. The method of claim 1, wherein the process is performed when intelligence data is received.

6. The method of claim 1, further comprising displaying a static analysis report, representing the results of performing the process on the basis of archived SDO data.

7. The method of claim 6, further comprising the step of receiving data representing a time range, and modifying the archived SDO data so that each SDO has that time range.

8. The method of claim 1, wherein the geographical radius is displayed as a shaded area superimposed on the threat map.

9. The method of claim 1, wherein the time bar is displayed as a bar under the threat map.

10. A computer-readable medium containing programming for implementing the following method of organizing, storing, and analyzing intelligence data, comprising:
generating a number of SDOs (standardized data object) based on the intelligence data, each SDO containing data representing source intelligence or target intelligence or both;
storing operational data representing targets;
storing a number of data fusion processes, each data fusion process representing one of the following threats:
the existence of SDOs at any location within a specified region at during the same time;
the existence of SDOs at a specified target location;
the existence of SDOs in a specified population area;
the existence of SDOs during a specified event;
the existence of SDOs during a specified transport activity;
processing the SDOs, operational data, and at least one data fusion process to determine if any SDOs indicate a threat;
displaying a threat map, which displays one or more SDOs in that location, each SDO having a geographical radius and a time bar.

11. The medium of claim 10, wherein each SDO contains data representing a corroboration level.

12. The medium of claim 10, wherein each SDO contains data representing a reliability factor.

13. The medium of claim 10, further comprising the step of generating alert data if one or more SDOs are coherent in time and location.

14. The medium of claim 10, wherein the process is performed when intelligence data is received.

15. The medium of claim 10, further comprising displaying a static analysis report, representing the results of performing the process on the basis of archived SDO data.

16. The medium of claim 10, wherein the geographical radius is displayed as a shaded area superimposed on the threat map.

17. The medium of claim 10, wherein the time bar is displayed as a bar under the threat map.
